(19) United States
(12) Patent Application Publication
(10) Pub. No.: US 2013/0315653 A1
(43) Pub. Date: Nov. 28, 2013

(54) FLOOR TREATMENT APPLIANCE ARRANGEMENT

(71) Applicant: Euro-Pro Operating LLC, Newton, MA (US)

(72) Inventor: David Jalbert, Coventry, RI (US)

(73) Assignee: Euro-Pro Operating LLC, Newton, MA (US)

(21) Appl. No.: 13/783,222

(22) Filed: Mar. 1, 2013

Related U.S. Application Data
(60) Provisional application No. 61/651,966, filed on May 25, 2012.

(51) Int. Cl. A47L 11/40; B25G 3/38; A47L 13/42

(52) U.S. Cl. CPC A47L 11/40; A47L 13/42; B25G 3/38
USPC 403/119

(57) ABSTRACT

A floor treatment appliance has an appliance body which pivots and swivels relative to an appliance head. One or more aspects may facilitate steering and maneuvering of the appliance. A swivel joint may be located within a region of the appliance body which has a lower slope as compared to other portions of the appliance body. The appliance body may be mounted to the top of the appliance head. The swivel joint may be positioned directly above the appliance head.

### RELATED APPLICATIONS

This Application claims the benefit under 35 U.S.C. §119(e) of U.S. Provisional Application Ser. No. 61/651,966, filed on May 25, 2012, entitled “Cleaning Apparatus”, which is hereby incorporated by reference.

### FIELD

Aspects herein generally relate to floor treatment appliances, and more specifically to steering and maneuverability arrangements of such appliances.

### DISCUSSION OF RELATED ART

Upright appliances such as vacuum cleaners, dry mops, steam mops, sweepers, floor polishers, etc. include various steering arrangements to help users maneuver the appliances across the floor and manipulate their orientation. Some appliances include a pivoting and swiveling arrangement which allows a user to turn an appliance head by twisting a handle about a longitudinal axis of the handle.

### SUMMARY

According to one embodiment, an appliance includes an appliance head having a front edge and a rear edge, a body which is pivotally movable relative to the appliance head, the body including a lower body portion and an upper body portion, and a handle grasping portion. The appliance further includes a swivel joint which permits the lower body portion to swivel relative to the upper body portion, the lower body portion being below the swivel joint, and the upper body portion being above the swivel joint. There is also a connection between the lower body portion and the appliance head, wherein at least a portion of the connection between the lower body portion and the appliance head is located forward of the rear edge of the appliance head by at least one quarter of a distance between the rear edge and the front edge.

According to another embodiment, an appliance includes an appliance head, a body which is pivotally movable relative to the appliance head, the body including a lower body portion and an upper body portion, and a handle grasping portion. The appliance also includes a swivel joint which permits the lower body portion to swivel relative to the upper body portion, the lower body portion being below the swivel joint, and the upper body portion being above the swivel joint. The body has a first slope at the swivel joint, and the upper body has a second slope above the swivel joint. The lower body has a third slope below the swivel joint, and the first slope is less than the second slope and the third slope.

In a further embodiment, an appliance includes an appliance head, a body which is pivotally movable relative to the appliance head, the body including a lower body portion and an upper body portion, and a handle grasping portion. The appliance further includes a swivel joint which permits the lower body portion to swivel relative to the upper body portion, the lower body portion being below the swivel joint, and the upper body portion being above the swivel joint. The lower body portion extends from the appliance head at a first angle relative to a horizontal reference plane, and the lower body portion has a curve such that an upper region of the lower body portion forms a second angle relative to the horizontal reference plane that is smaller than the first angle.

According to yet another embodiment, an appliance includes an appliance head, and a body including a lower body portion and an upper body portion, wherein the body is pivotally movable relative to the appliance head. The appliance also includes a handle grasping portion and a swivel joint which permits the lower body portion to swivel relative to the upper body portion. The lower body portion is below the swivel joint, and the upper body portion is above the swivel joint. The swivel joint has a swivel axis which, when extended along an imaginary axis, passes above the pivot axis.

According to a further embodiment, an appliance includes an appliance head and a body including a lower body portion and an upper body portion, wherein the body is pivotally movable relative to the appliance head. Also includes is a handle grasping portion and a swivel joint which permits the lower body portion to swivel relative to the upper body portion about a swivel axis. The lower body portion is below the swivel joint, and the upper body portion is above the swivel joint. An imaginary line extending from the handle grasping portion to the swivel axis at the swivel joint forms an angle with the swivel axis of less than 130 degrees on the side of the swivel joint where the swivel axis points downwardly.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. Various embodiments of the invention will now be described, by way of example, with reference to the accompanying drawings, in which:

FIG. 1 is a top view of an appliance with a conventional swivel and pivot steering arrangement in a non-swiveled position;

FIG. 2 is a top of the appliance of FIG. 1 in a swiveled position;

FIG. 3 is a side view of the appliance of FIG. 1 in a non-swiveled position;

FIG. 4 is a side view of the appliance of FIG. 1 in a swiveled position;

FIG. 5 shows a schematic appliance arrangement according to one embodiment to of the invention;

FIG. 6 shows a top view of the appliance head of the schematic appliance arrangement shown in FIG. 5;

FIG. 7 shows a floor treatment appliance with a pivot and swivel arrangement according to one embodiment;

FIG. 8a shows two different pivot positions of the embodiment of FIG. 6;

FIG. 8b shows relationships of the swivel axis to the appliance head and the appliance body;

FIG. 9 shows a top view of the appliance in a swiveled position;

FIG. 10 shows a front view of the appliance in the swiveled position of FIG. 8a;

FIG. 11 shows a side view of the appliance in a swiveled position;

FIG. 12 is a side view of a swivel assembly according to one embodiment with the floor treatment appliance in a home swivel position;

FIG. 13 is a side view of a locking arrangement of the floor treatment appliance of FIG. 1 with the floor treatment appliance in a storage position;

FIG. 14 is a side view of the swivel assembly of FIG. 12 with the floor treatment appliance in a storage position;

FIG. 15 is a side view of a locking arrangement of the floor treatment appliance of FIG. 1 with the floor treatment appliance in a use position;

FIG. 16 is a side view of the swivel assembly of FIG. 12 with the floor treatment appliance in a use position;

FIG. 17 is a side view of the swivel assembly of FIG. 12 with the floor treatment appliance in a use position and in a non-home swivel position;

FIG. 18 is an enlarged side view of a moveable lock-prevention member according to one embodiment when the floor treatment appliance is brought from a non-home swivel position to a home swivel position;

FIG. 19 is a side view of the swivel assembly of FIG. 12 when the floor treatment appliance is brought from a non-home swivel position to a home swivel position;

FIG. 20 is an exploded perspective view of the swivel and lock assembly of FIG. 12; and

FIG. 21 is an exploded perspective view of a swivel joint according to one embodiment.

### DETAILED DESCRIPTION

Some conventional floor treatment appliances, such as vacuum cleaners, include a swiveling and pivoting arrangement between the appliance body and the appliance head which allows the user to turn the appliance head by twisting the appliance body about its longitudinal axis. When the user twists the body, for example by twisting his or her wrist while holding a handle at the top of the body, the swivel and pivot configuration rotates the appliance head about a vertical axis.

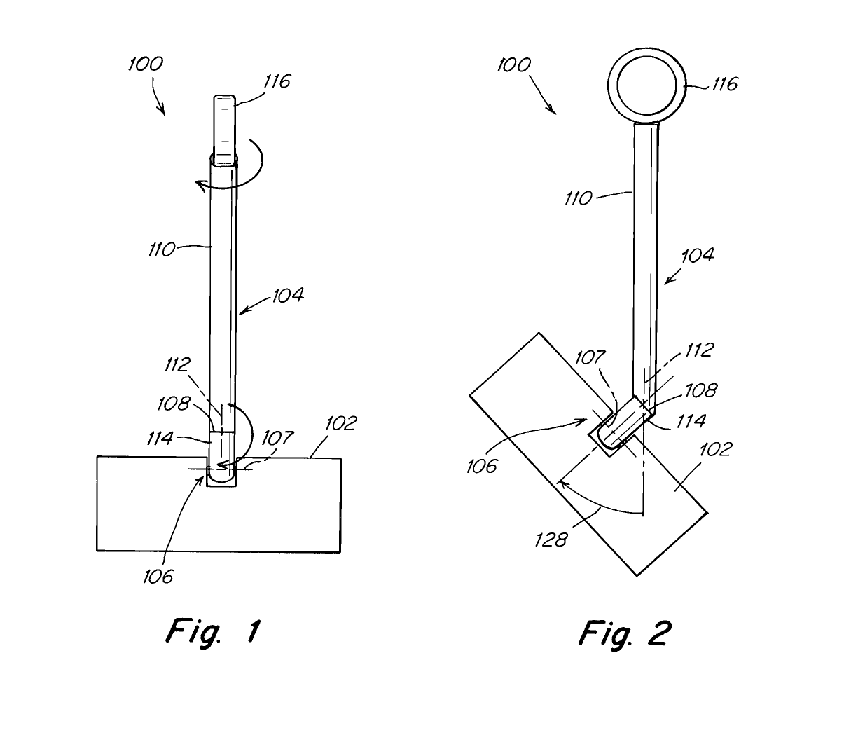

FIGS. 1-4 show one example of such a conventional arrangement. The side view of FIG. 1 shows an appliance 100 having an appliance head 102 and a body 104 which extends from head 102 at an adjustable angle Z. Body 104 is attached to head 102 with a pivot joint 106 such that body 104 is pivotable in the forward and rearward directions about a pivot axis 107. Body 104 includes a swivel joint 108 which allows an upper body portion 110 to swivel about a swivel axis 112 relative to a lower body portion 114. A handle 116 at an upper end of body 104 allows a user to manipulate the body and appliance head.

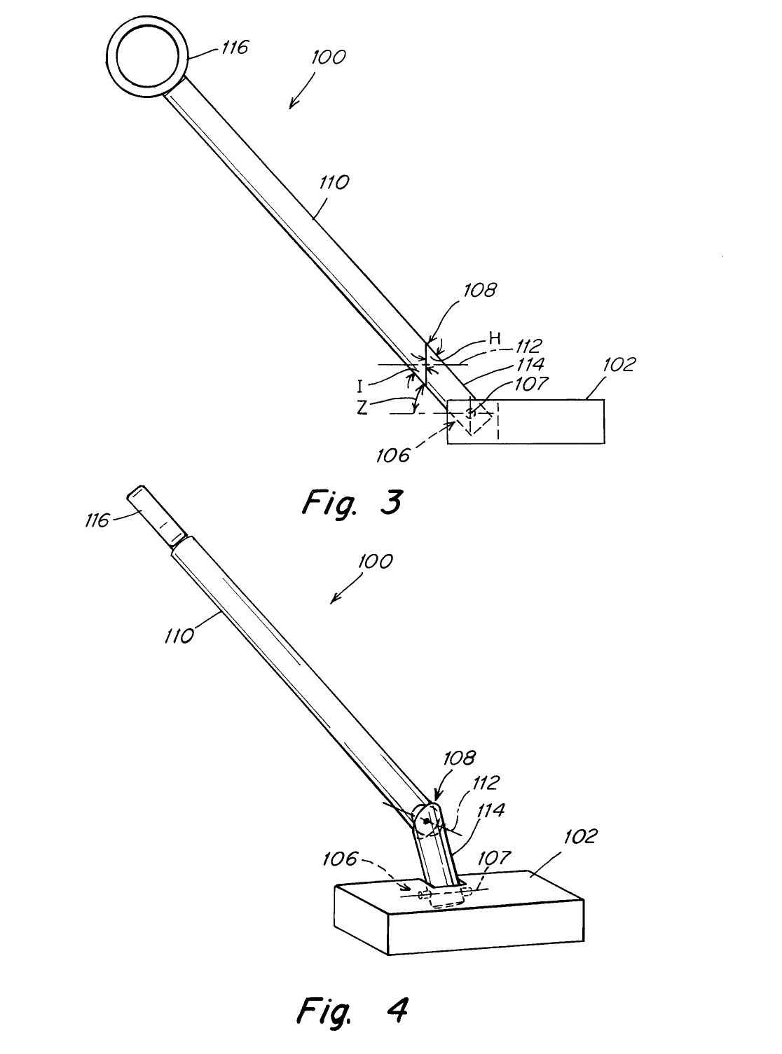

When the user twists the handle about its longitudinal axis, for example by ninety degrees as shown in FIG. 2, but otherwise holds constant the orientation of the handle relative to the floor, appliance head 102 turns within its horizontal plane. Rotations about pivot axis 107 and swivel axis 112 allow the body 104 to remain in a similar orientation relative to the user while the appliance head turns. FIG. 3 shows a top view of the appliance prior to the user twisting the body, and FIG. 4 shows the appliance after a ninety degree rotation of the body, resulting in an approximately forty-five degree rotation of the head.

Swivel joint 108 is formed with abutting faces which are oriented at a non-perpendicular angle relative to the longitudinal axis of the body 104. If the interface of the abutting faces were oriented normal to the body's longitudinal axis is the illustrated arrangement, such that the swivel axis would be oriented along the length of the upper body portion, twisting the upper body portion 110 would not have an effect on the rotation of the appliance head. Instead, the upper body portion would simply rotate about its longitudinal axis and not rotate the lower body portion.

With the swivel joint cut into the body such that the interface is oriented at a non-perpendicular angle relative to the body, rotation of the upper body forces the lower body to pivot about the pivot axis, and the appliance head to pivot about a vertical axis. The vertical rotation axis may pass through the swivel joint in some cases. Throughout this application, references to various rotation axes do not require the presence of physical longitudinal components along a given rotation axis. Instead, a rotation axis can simply be an imaginary axis about which various components rotate.

Applicant has appreciated that the non-perpendicular orientation of the abutting faces can present difficulties when components are to be housed within the appliance body. The angled interface forms acute angles H and I as noted in FIGS. 1 and 2. These acute angles leave constrained volumes which can lead to difficulties in assembly and/or positioning of components within the housing, including components of the swivel joint itself. Accordingly, in some embodiments of the present disclosure, an appliance body is configured such that a swivel joint interface is oriented at an angle that is closer to perpendicular with the appliance body than would otherwise be possible to achieve similar steering and maneuverability capabilities.

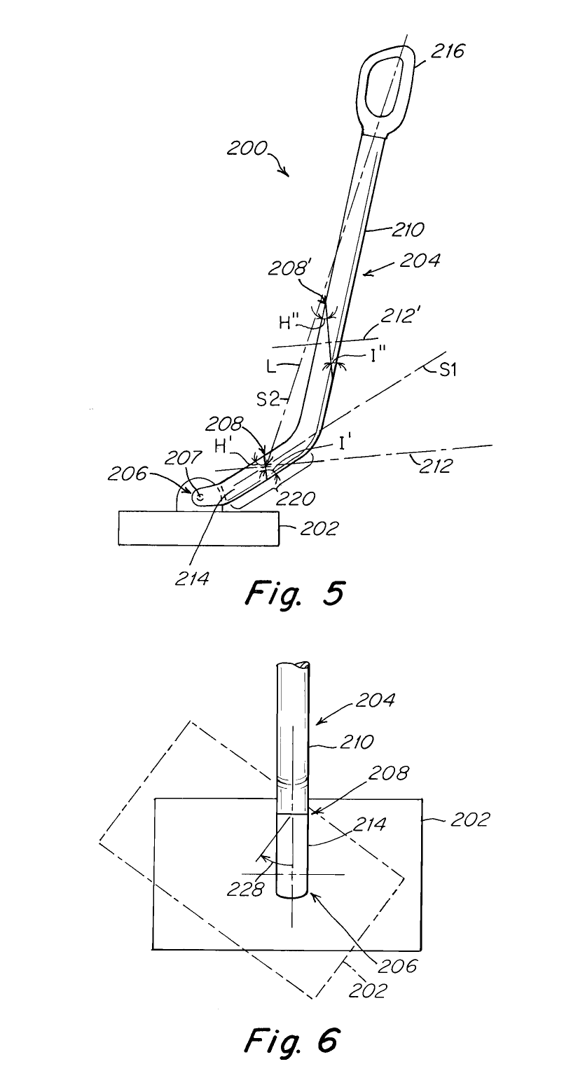

For example, in one embodiment, as illustrated in FIG. 5, an appliance body 204 has a region 220 with a slope that is less steep than other portions of the body. The swivel joint interface is located within this lower slope region 220 of the body such that an angle H′ and an angle I′ are closer to perpendicular with the appliance body than in other arrangements, such as the arrangement shown in FIG. 1. Even though the interface angle is closer to perpendicular, the swivel and pivot steering arrangement still operates similarly well because the angle of the swivel interface relative to an imaginary line L extending between a handle 216 and the swivel joint is not changed by much, if at all, as compared to the arrangement of FIG. 1. In this respect, the angle of the swivel joint interface is changed relative to the local region 205 of the body, but not necessarily changed very much relative to line L or the overall appliance body.

With a larger intersection angle H′, the positioning of components within the appliance body may be improved. Further, in some embodiments, the ease of assembly may be improved. In some embodiments, the swivel joint interface may be oriented such that angles H′ and I′ are perpendicular to appliance body 204.

According to another aspect of some embodiments disclosed herein, the appliance body is attached to an appliance head forward of a rear edge of the appliance to head. In some cases, the appliance body is attached to a top of the appliance head at a point approximately halfway between a front edge and the rear edge of the appliance head. By attaching the appliance body to the head at a position other than the rear edge of the head, turning the head may be made easier. When a user twists the appliance body but maintains the overall orientation of the upper body relative to the floor, the appliance head rotates about a vertical axis which passes through the approximate location of the swivel joint. Accordingly, when the swivel joint is positioned at a distance behind the appliance head, the head has an arc along which the head travels when turning. Moving the swivel joint closer to the appliance head reduces the length of this arc, thereby easing turning in some embodiments. Positioning the swivel joint directly above the appliance head, as can be seen in FIG. 6, can further reduce the arc length, and portions of the head hardly have to move at all.

In some embodiments, a connection of the lower body portion to the appliance head is located forward of the rear edge of the appliance head by at least a quarter of the distance from the rear edge to a front edge of the appliance head.

According to another aspect of embodiments disclosed herein, the appliance body may have a shape below the swivel joint which allows the body to be pivoted rearwardly to a low angle relative to the floor. For example, in some embodiments where the swivel joint interface is located on a body region with a relatively lower slope, and the body is mounted to the top of appliance head, the lower slope region of the body may limit the rearward pivot of the body. FIG. 5 shows one embodiment of such an arrangement. As can be seen, the appliance body would contact the upper surface of the head after being pivoted rearwardly by only a limited angle. Such an arrangement may limit the usability of the appliance in terms of accessing areas under furniture.

Similarly, for embodiments where the lower body portion is mounted to the appliance head at a rear edge of the head, a body region with a lower slope may contact the floor as the body is pivoted rearwardly, undesirably limiting how low the body can be pivoted.

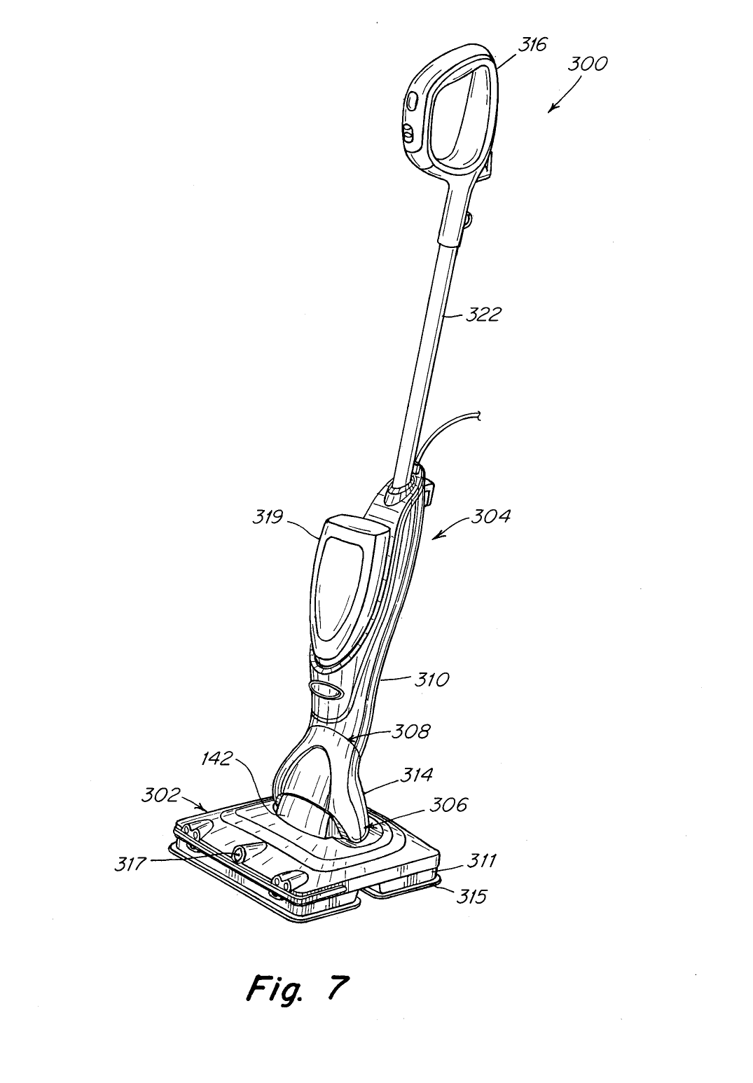

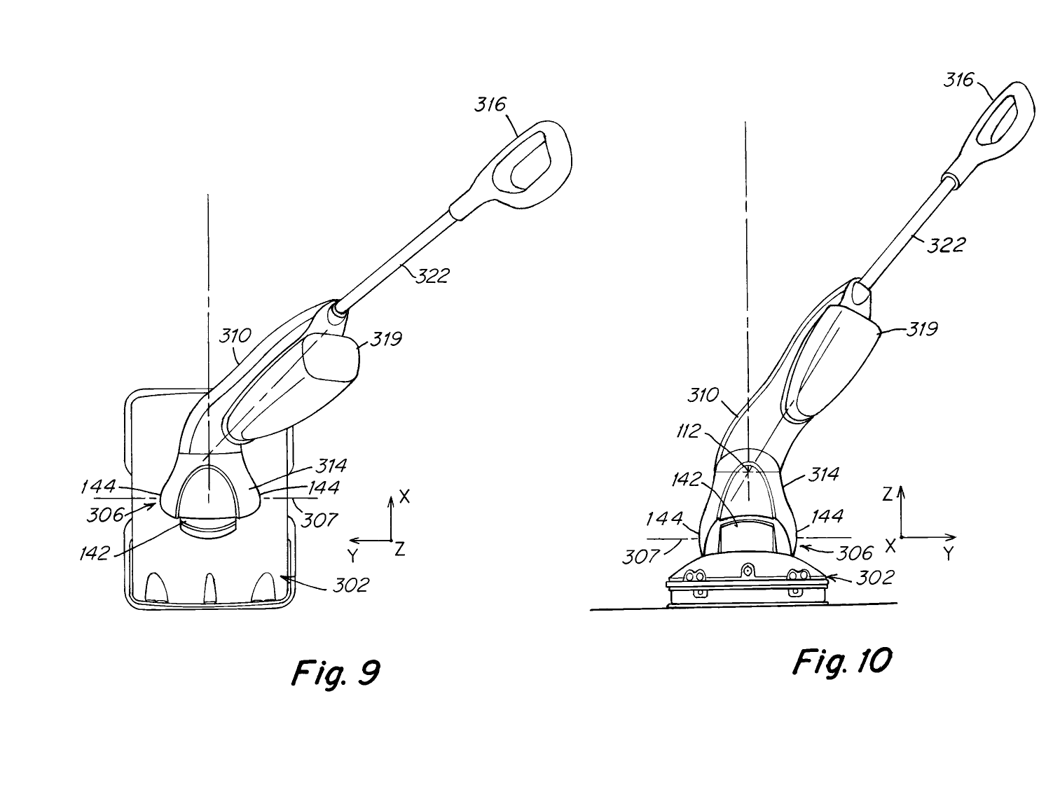

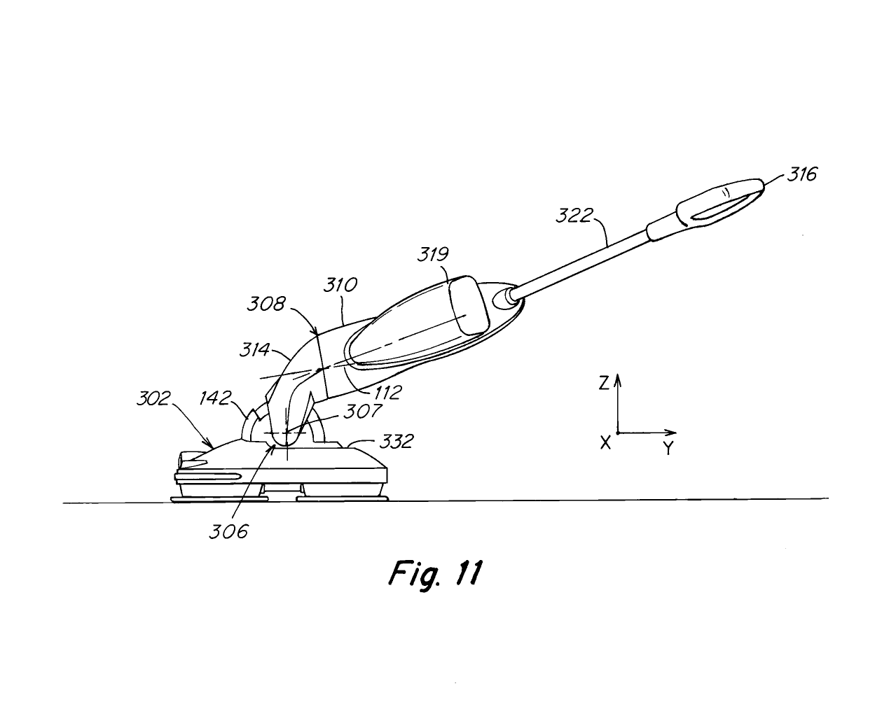

To permit the body to reach a lower angle by pivoting in the rearward direction, the lower body portion may be shaped to have an increased slope relative to the swivel joint region, as shown in FIGS. 7-11. When the body is pivoted rearwardly, the shape of the lower body portion maintains the body above the head until the body reaches a low angle relative to the floor.

Turning to certain embodiments illustrated herein, FIG. 5 shows an appliance 200 with an appliance head 202, a body 204, a pivot joint 206, a pivot axis 207, and a swivel joint 208 which swivels about a swivel axis 212. The area above the swivel joint 208 includes an upper body portion 210 and a handle 216, while the area below the swivel joint 208 includes a lower body portion 214.

In the illustrated embodiment, a swivel joint region 220 of the body has a slope S₁. An imaginary line L extending from the swivel joint 208 to the handle 216 has a slope S₂ which is greater than slope S₁. By providing the swivel joint region 220 with a lower slope, line L maintains a sizeable angle with the swivel axis 212 while increasing angles H′ and I′ so that angles H′ and I′ are less acute. For example, if the swivel joint 208 were to be located on the portion of the body that has a higher slope (see imaginary swivel joint 208′), yet maintained a similarly-oriented swivel axis 212′ (i.e. parallel to swivel axis 212), resulting angles H″ and I″ would be more acute. Such angles might lead to difficulties with components arrangement and/or assembly.

FIG. 6 shows a top view of the embodiment of FIG. 5, and illustrates how mounting the body to the appliance head forward of the rear edge may help reduce the length of an arc 228 along which the head 202 travels when being turned. Referring back to FIG. 4, a longer arc 128 may results when a swivel joint is positioned rearwardly from the head.

Various types of appliances my incorporate aspects disclosed herein. For example, vacuum cleaners, dry mops, steam mops, sweepers, floor polishers, or other appliances may be used. In the embodiment illustrated in FIGS. 7-11, a reciprocating floor treatment appliance 300 is used to describe various aspects, though any suitable appliance may be outfitted with one or more of the features described herein.

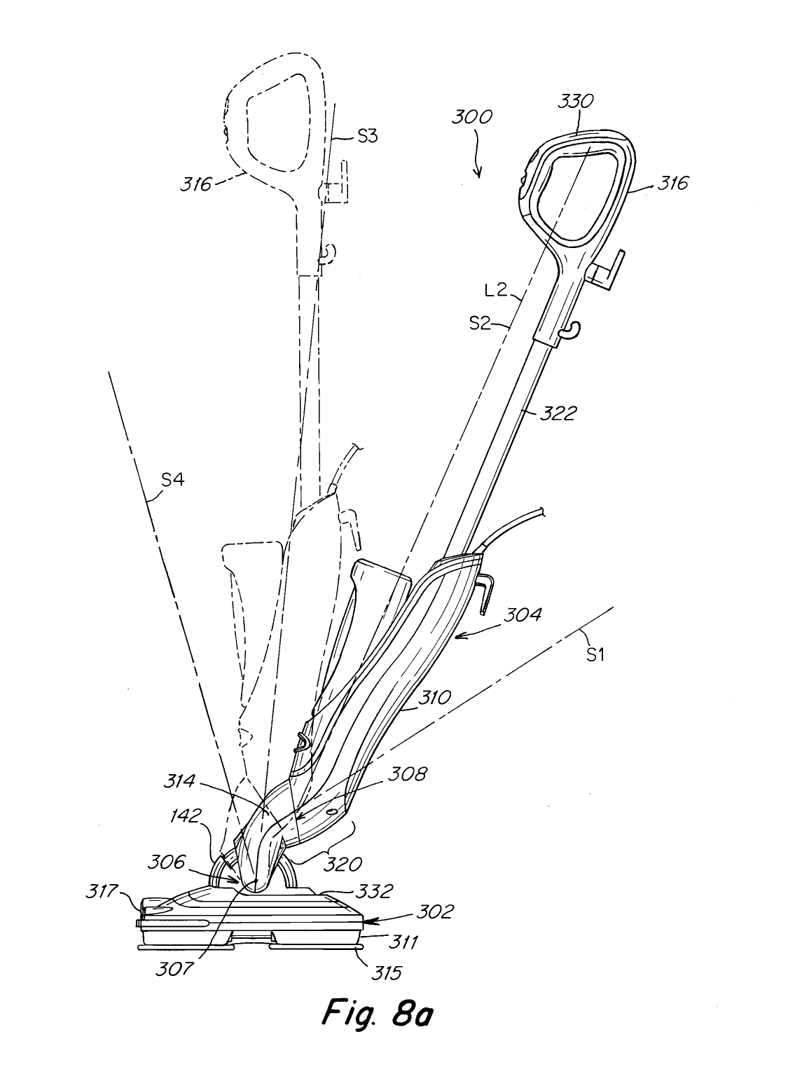

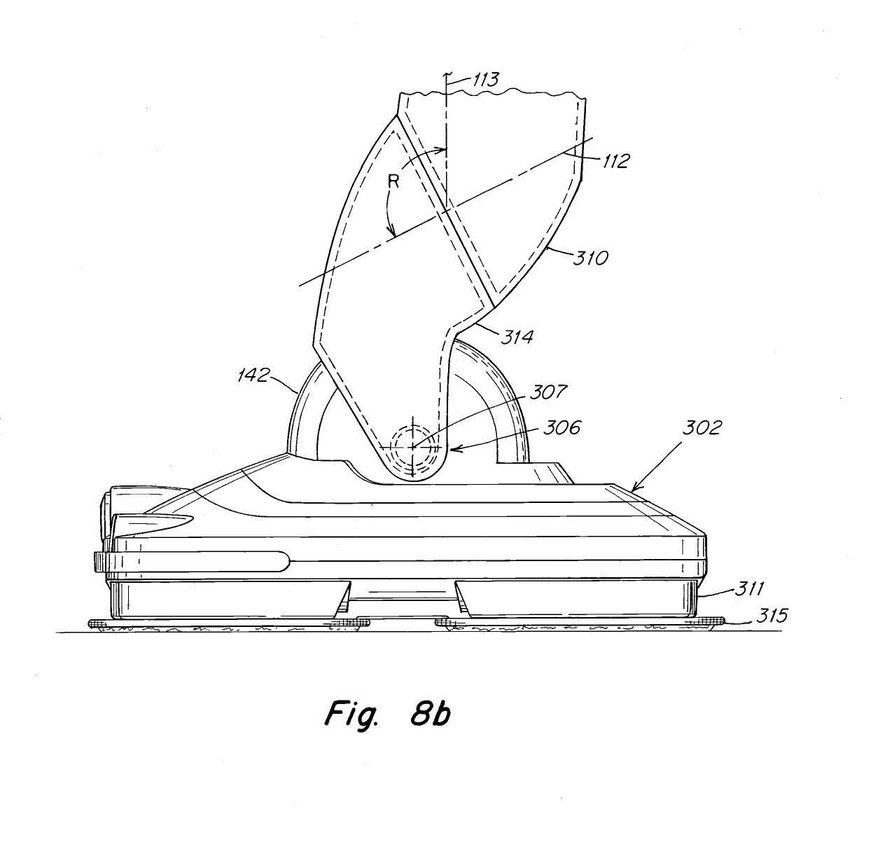

Appliance 300 includes an appliance head 302 and a body 304 pivotally connected to the appliance head at a pivot joint 306. The pivot connection allows the body to pivot forward and rearward relative to the appliance head when used to treat a floor surface. A user also may lock the body relative to the appliance head in a storage position. FIG. 8a illustrates the body in the storage position (dashed lines), and in the use position (solid lines), according to one embodiment. The body may be in the storage position when the body is brought fully forward and to an upright position; however, the body need not be in a fully upright position to be in a storage position in some embodiments, but may be in any desirable position convenient for storing.

According to some embodiments, the floor treatment appliance 300 is a reciprocating cleaning appliance. In such an embodiment, the appliance head 302 includes one or more moveable cleaning members 311 to which a surface treatment pad 315 may be attached. The moveable members are powered by an electric motor and move linearly back and forth across the floor. The moveable members may move toward and away from each other in some embodiments, or in the same direction in some embodiments. The appliance head may further include a liquid applicator 317 that sprays or otherwise applies cleaning liquid stored in a liquid reservoir 319.

According to some embodiments, the body 304 may include a handle 316 connected by a pole 322 to a housing portion of the body. The body 104 may further include a swivel joint 308 that allows a portion of the body to swivel relative to the appliance head 302. The swivel joint 308 may include a swivel disk, as discussed below, forming a rotating connection between a lower portion 314 of the body and an upper portion 310 of the body. The appliance body does not necessarily need to include a housing portion as the body may be formed completely, or nearly completely of a pole similar to pole 322. Handle 315 may be as simple as a top region of pole 322, options with a grip material attached to the pole.

As illustrated in FIG. 8a, the appliance body 304 includes a swivel joint region 320 where the body has a slope S₁. An imaginary line L₂ between the swivel joint 308 and a handle grasp portion 330 of the handle 316 has a slope S₂ which is greater than slope S₁. Additionally, the lower body portion 314 is mounted on top of the appliance head 304, and the lower body portion includes a region having a slope S₃. Slope S₃ is greater than slope S₁ in the illustrated embodiment. Further, in some embodiments, slope S₃ may be greater than slope S₂. The region of the lower portion having slope S₃ may have a vertical slope, or may have a slope that goes past vertical and forms an angle with the floor on the opposite side of vertical in some embodiments, or in some pivot positions of the embodiment illustrated in FIG. 8a. For purposes herein, slope S₃ in such arrangements would be considered as having a greater slope than body regions with slopes that have not reached vertical for purposes herein. That is, body portions which have a slope that is past vertical are considered to have a greater slope than body portions which are not past vertical.

It can also be seen in FIG. 8a how the shape of lower body portion 314 permits the body to be pivoted rearwardly to a low angle about a pivot axis 307 before a portion to of the body contacts an upper surface 332 of the appliance head. In some embodiments, pole 322 forms an angle of approximately thirty degrees with the floor when the body is pivoted rearwardly to its lowest possible angle. In some embodiments, a lowest rearwardly pivoted angle is approximately twenty degrees.

When the body is brought to its forward most pivoting position (see dashed lines of FIG. 8a), lower body portion 314 has a forward leaning slope S₄, that is, a slope that is past vertical. In some embodiments, the lower body portion does not have a forward leaning slope in its forward most position. In some embodiments which include a lower body portion with a forward leaning slope in its forward most position, the body does not necessarily include other aspects disclosed herein. For example, such an embodiment may not include a swivel joint region having a lower slope than an imaginary line between the handle grasp portion and the swivel joint.

Swivel joint 308 is position directly above appliance head 302 in the embodiment illustrated in FIG. 8a. As discussed above, such an arrangement allows the appliance head to travel along a shorter arc as compared to an arrangement where the swivel joint is positioned directly above the floor behind the rear edge of the head.

According to one advantageous aspect of some embodiments, arrangements disclosed herein may permit a desirable rotation of the appliance head relative to a user's twisting of his or her wrist. In some embodiments, this twist to head rotation ratio is achieved by arranging the swivel axis in certain ranges of positions and/or orientations. For example, as may be seen in FIG. 8b, an imaginary line extending from swivel axis 112 toward the front of the appliance head passes above pivot axis 307. In some embodiments, this imaginary line extension does not intersect with the appliance head when the body is brought to its full upright position. In other embodiments, this imaginary line extension intersects with a front half of the appliance head when the body is brought to its full upright position.

In some embodiments, the appliance provides an angle R between swivel axis 112 and an imaginary line 113 that extends from the swivel axis at the swivel joint to a handle grasp position on the upper body. In some embodiments, angle R is less than 130 degrees. In some embodiments, angle R is anywhere between 115 degrees and 125 degrees inclusive. In some embodiments, angle R is 120 degrees. Or, in some embodiments, angle R is between 110 degrees and 125 degrees. By selecting a suitable angle R, the appliance can be configured to provide a handle twist to head rotation ratio to that is comfortable to the user. For example, in some embodiments, an angle R of between 115 and 125 degrees provides a head rotation of between 60 and 70 degrees when a user twists the upper body of the appliance 90 degrees.

According to one embodiment, the lower body portion 314 body is yoke-shaped, as can be seen in FIG. 10, and each extending end 144 of the yoke is pivotally connected to the appliance head 302. The appliance head may have a rounded portion 142, with the yoke-shaped body being configured to clear the rounded portion as the body pivots relative to the appliance head. The rounded portion may house a motor for driving the moveable cleaning members 311. Although a yoke-shaped body is disclosed, one of skill in the art would appreciate that the lower portion of body may be any suitable shape.

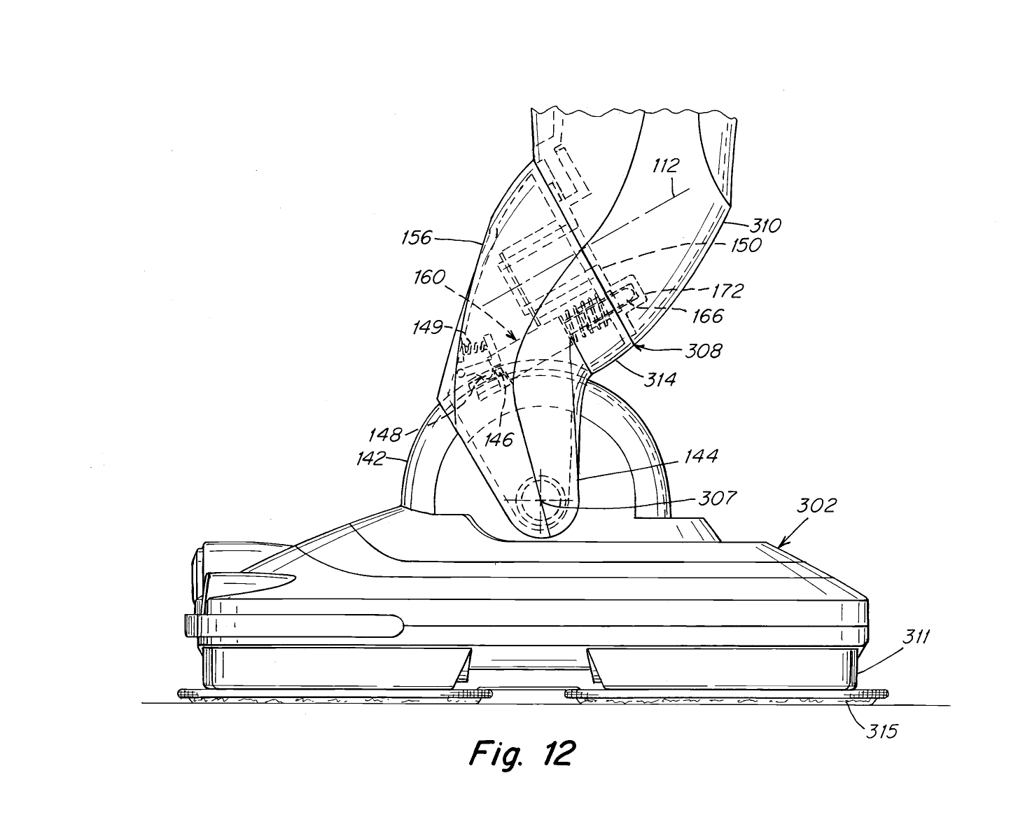

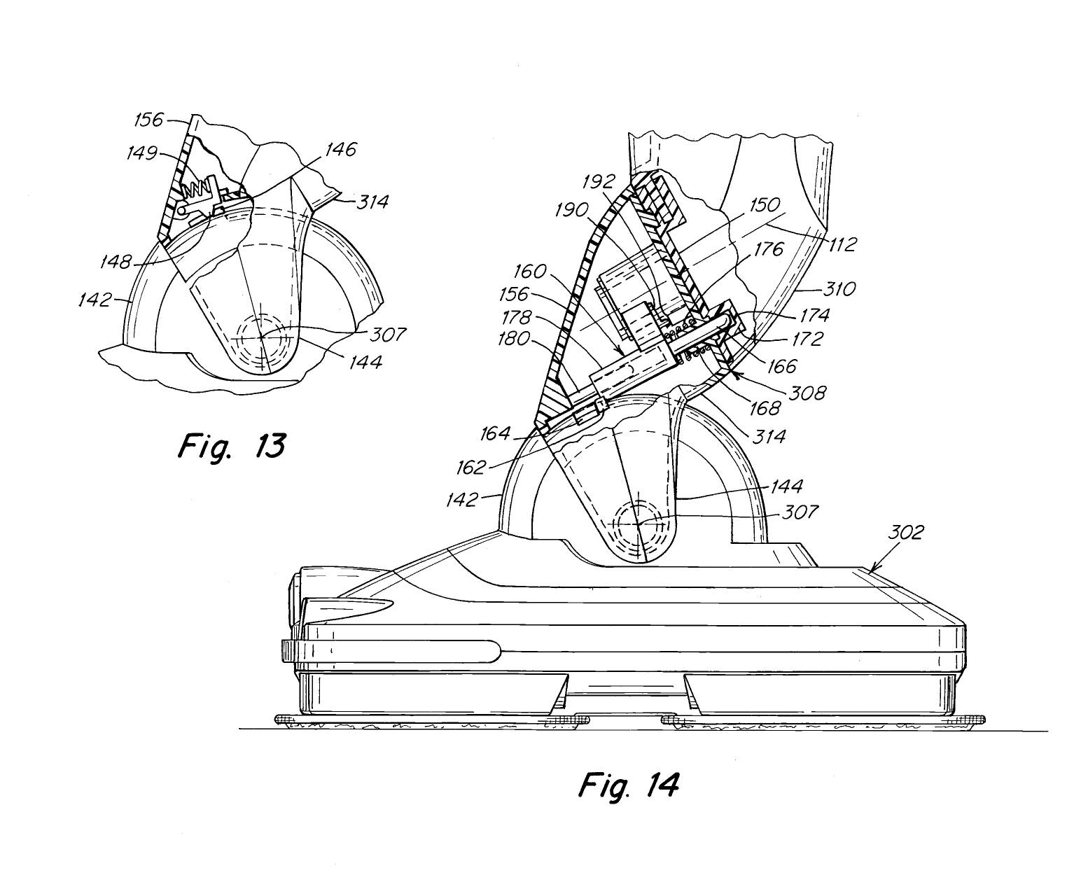

FIGS. 12 and 13 illustrate a locking device for locking the pivoting of the body 304 according to one embodiment. The appliance head includes a first locking member 146 configured to engage a second locking member 148 on a portion of the body 304. When the user brings the body to the storage position, the locking members engage to pivotally lock the body. The user may release the locking members from each other simply by pulling rearwardly on the handle while stepping on the appliance head.

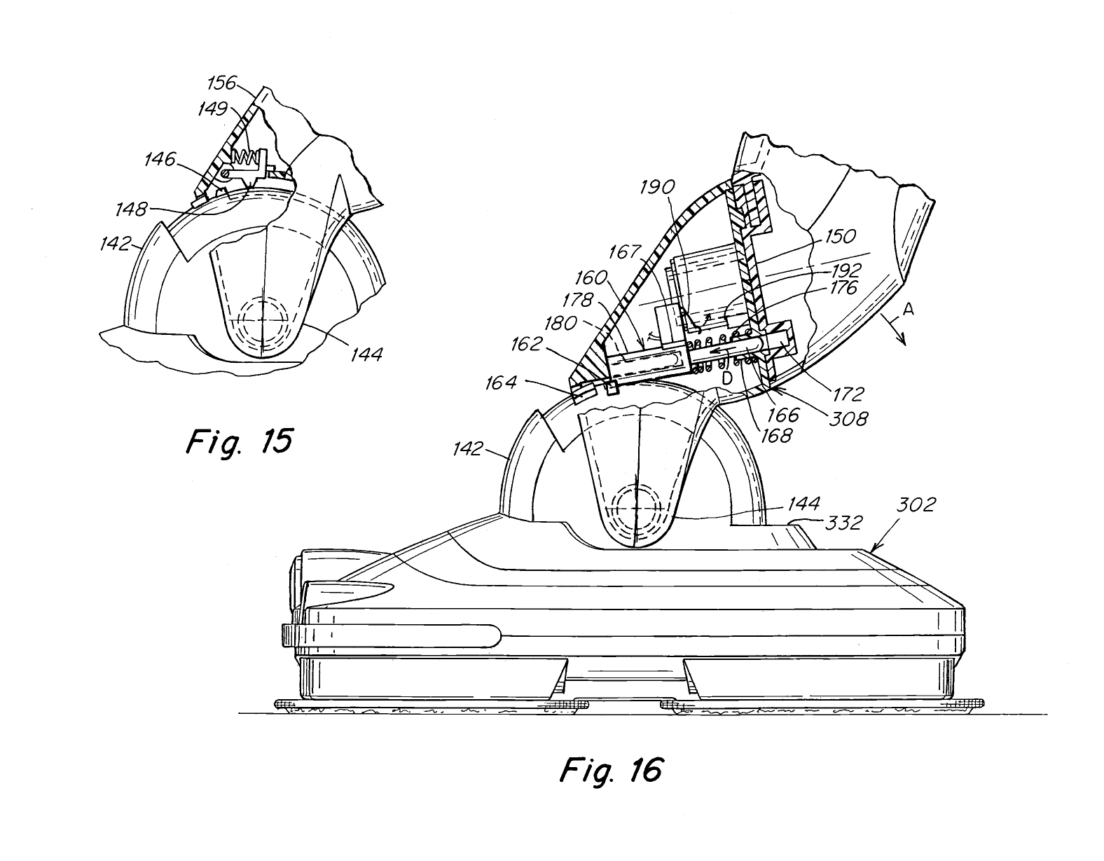

In the embodiment shown, the first locking member 146 is a protrusion on the rounded portion of the appliance head, and the second locking member 148 is a spring-biased catch arranged in the body to pivot with the body over the rounded portion of the appliance head. The protrusion is arranged on the appliance head such that when the body is brought forward toward the upright storage position, the spring-biased catch passes over the protrusion and is pressed downwardly by a spring 149 upon reaching the opposite side of the protrusion, as shown in FIG. 13. Although described herein as a lock, the locking arrangement does not permanently lock the body, nor does the locking arrangement necessarily include a component that the user has to separately move relative to the body or appliance head before pulling on the handle. For example, to unlock the body from the upright storage position, the user may pull the body backwards in the direction of arrow A of FIG. 15, exerting sufficient force to compress the spring 149 and push the catch away from the appliance head to release the catch from the protrusion, as shown in FIGS. 15 and 16. One of skill in the art will appreciate that other locking arrangements may be used, such as a magnetic lock, an interference lock, or any other type of suitable lock arrangement.

According to one embodiment, the body may include a moveable lock-prevention member 160 that prevents pivotal locking of the lower body portion in the storage position when the upper body portion is swiveled. In this embodiment, the storage position is an upright storage position and the body pivotally locks when the body is brought fully forward to the upright position. The lock-prevention member pivots with the body 304, moving relative to the appliance head. The lock-prevention member is slidable linearly between the swivel joint 308 and a front portion of the body 156, moving relative to the body 304. A portion of the lock-prevention member contacts a portion of the appliance head 302 when the lower body is brought forward toward the storage position with the upper body in the non-home swivel position. More specifically, a blocker 162 contacts a projection 164 on the appliance head, which prevents the spring-biased catch 148 from reaching the protrusion 146, thereby preventing the lower body from locking in the storage position.

When the body is in the home swivel position, the lock-prevention member 160 is allowed to slide rearwardly within the body such that the blocker(s) do not prevent the body from reaching the fully forward position. Accordingly, when the body is in the home swivel position, the body may be brought sufficiently forward for the locking members 146, 148 to engage with one another, thereby pivotally locking the body.

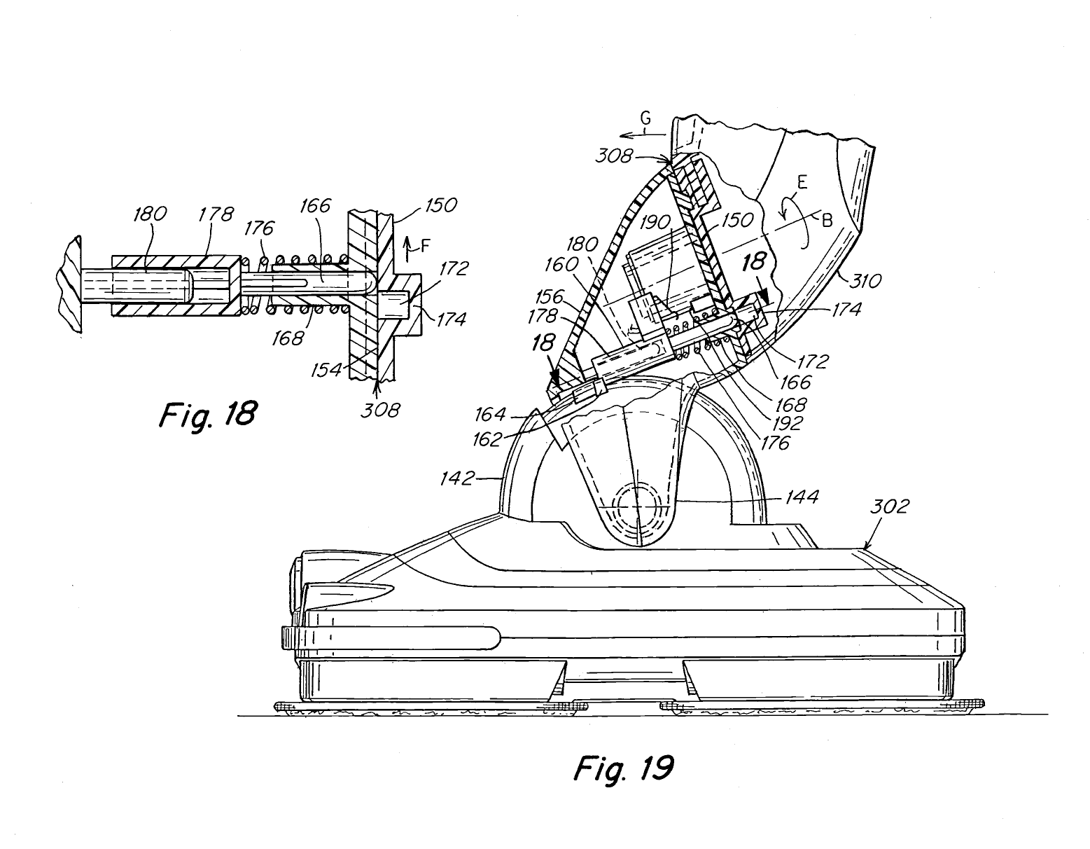

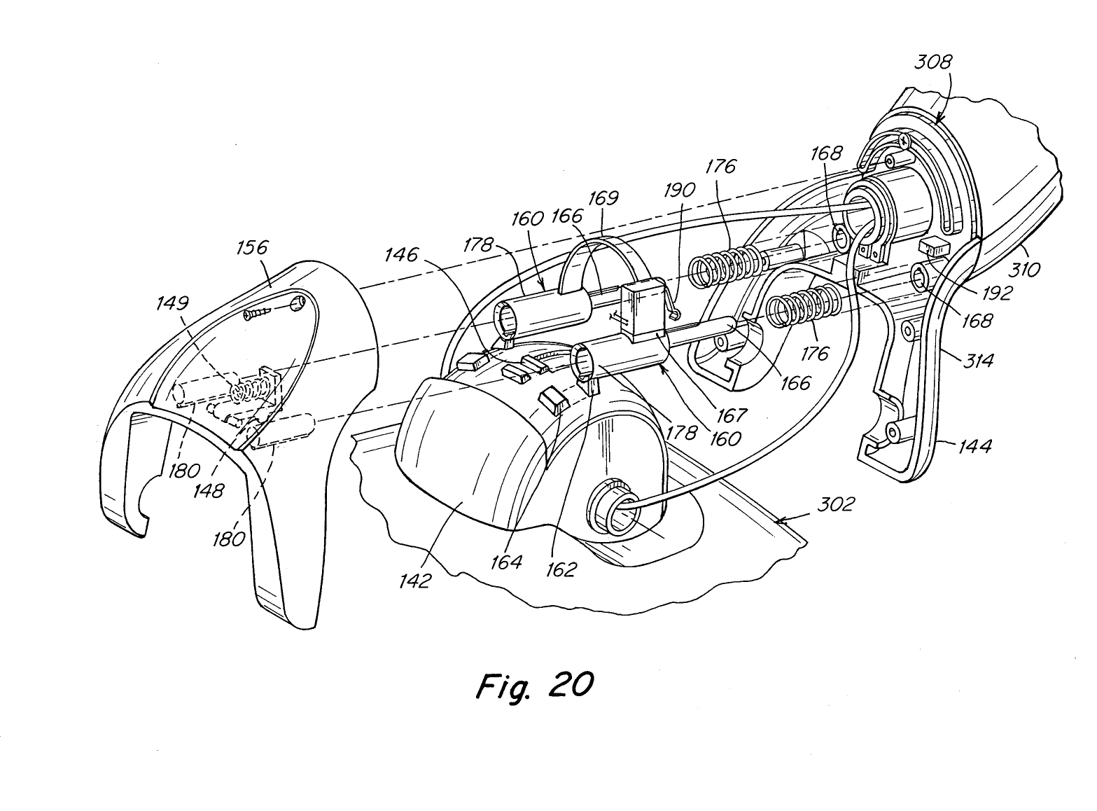

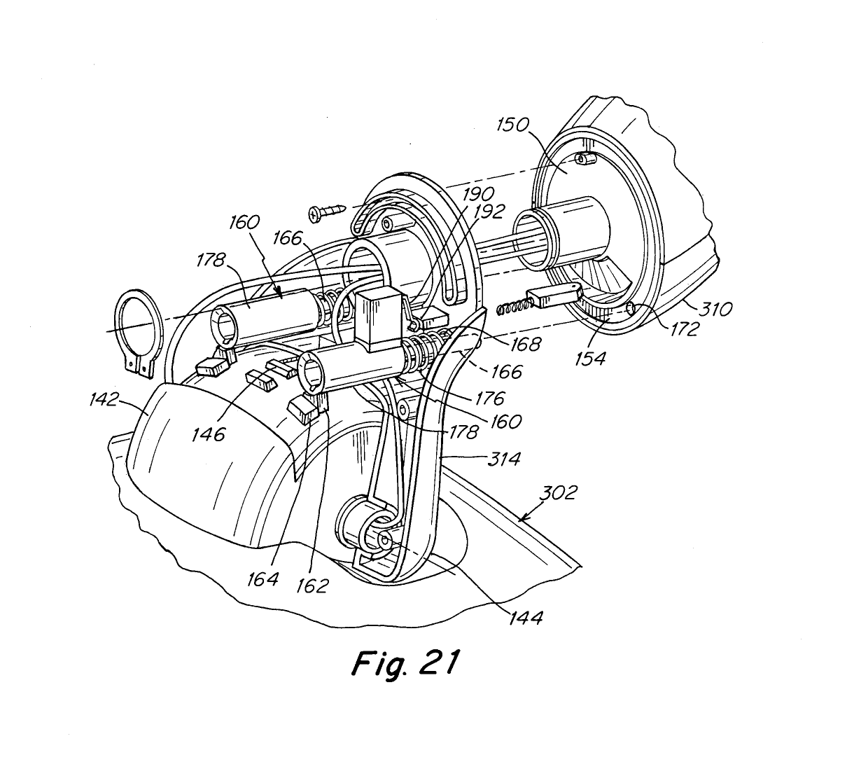

According to one embodiment, the lock-prevention member 160 may be a pin assembly having one or more extending pins 166, as shown in FIGS. 12 through 21. In a pin assembly having more than one pin, the pins may be connected by connecting member, such as an arch 169, as shown in FIG. 20, or other member, or they may not be directly connected to each other. The pins may slide linearly in a direction perpendicular to the swivel joint 308 in channels 168 located in the body at the swivel joint 308. The channels may extend into the swivel joint 308 such that the end of the channel contacts a surface of the swivel disk 150, as shown in FIG. 18. Opposite the extension pins, the pin assembly may include hollow channels 178 which slide on extensions 180 in the front portion of the body. Alternatively, the pin assembly may include one pin or channel that slides with respect to channels or pins located at the swivel joint and in the front portion of the body. The pins and channels may be cylindrical or any other suitable shape.

When the floor treatment appliance is in the storage position, the blockers 162 of the pin assembly are pushed against the protrusion 164 on the appliance head, as shown in FIG. 14. As a result, the pins 166 of the pin assembly are pushed into channel extensions 172 (or other openings) in the swivel disk. With the pins in the channel extensions of the swivel disk, the swivel disk is prevented from swiveling. In this manner, the upper body is prevented from swiveling.

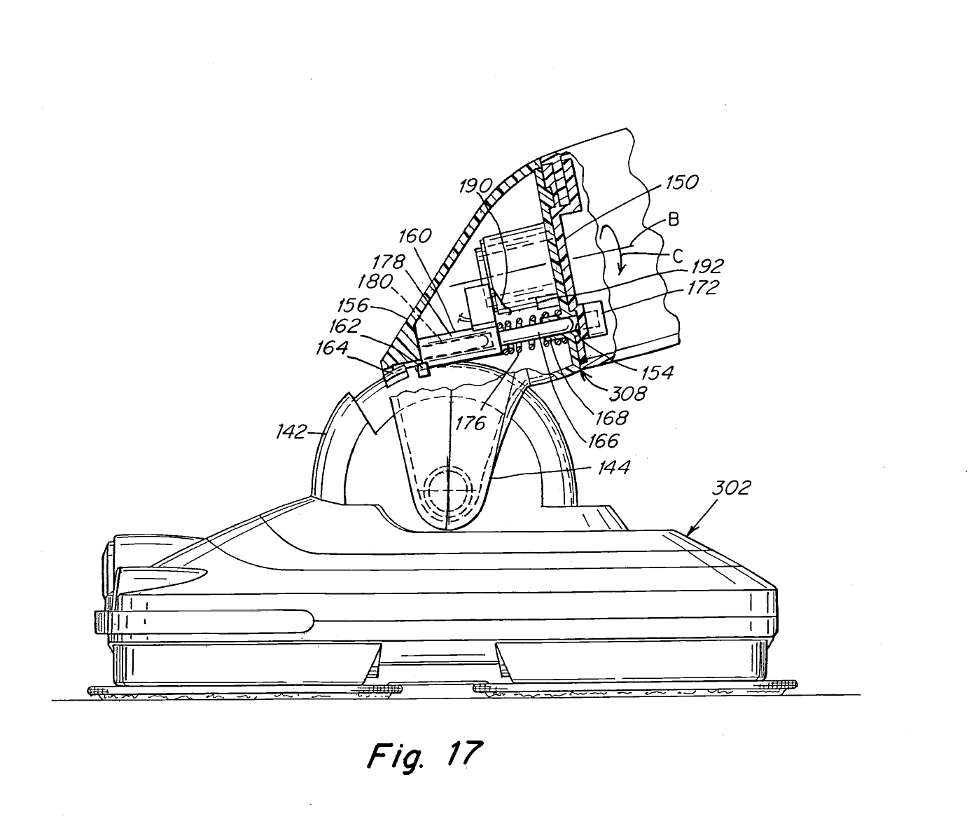

When the body is in the swiveled position, as illustrated in FIGS. 17 and 18, the channel extensions 172 do not align with the pins 166 of the lock-prevention member 160, and therefore the pins contact a surface of the swivel disk 150, preventing rearward movement of the lock-prevention member. FIG. 17 illustrates the lock-prevention member when the body is swiveled counter-clockwise in the direction of arrow C about axis B. The lock-prevention member is dimensioned such that when the body is swiveled, the pin 166 abuts a lower surface 154 of the swivel disk causing the blocker 162 to contact the projection 164 on the appliance head 102 before the lower body reaches the storage position. Accordingly, when the upper body is swiveled, the lower body is prevented from being brought sufficiently forward to allow the locking members 146, 148 to engage and pivotally lock the body.

FIGS. 17-19 illustrate the body swiveling from the non-home swivel position (FIGS. 17 and 18) to the home swivel position (FIG. 19). When the body rotates, the swivel disk may rotate with the body such that channel extension 172 rotates as well. According to one embodiment, when the body rotates about axis B in the direction of arrow E from the non-home swiveled position of FIG. 17 back to the home swiveled position of FIG. 19, the channel extensions 172 will move in the direction of arrow F of FIG. 18 to align with the channel 168. When the body is in the home swivel position, the channel extension aligns with the channel 168 to allow the pin 166 to extend into the channel extension. According to one embodiment, the channel extension 172 has an end wall 174, but the opening also may be a through hole in some embodiments. As a result of the pins 166 being permitted to enter the channel extensions 174, the body may then be able to be brought sufficiently forward in the direction of arrow G to allow the locking members 146, 148 to engage and lock the body in the storage position.

As mentioned above, the floor treatment appliance may include a moveable swivel-prevention member that prevents the body from swiveling when pivotally locked. In some embodiments, the swivel-prevention member locks the swivel whenever the body is brought to the storage position, and the storage position is when the body is in a fully forward pivot position.

In some embodiments, the swivel prevention member is part of the lock-prevention member 160 described above. When the body is brought to the storage position, the pin assembly contacts a portion of the appliance head which forces the pin 166 (or pins) into an opening in the swivel disk, for example channel extension 172. As shown in FIG. 14, the pin(s) act to secure the swivel disk 150 against rotation, thereby preventing the body from swiveling. In an alternative embodiment, the swivel-prevention member may be arranged as part of the appliance head which engages the swivel disk 150 when the body is brought to the storage position.

The swivel-prevention member may be biased to move the pin 166 out of the channel extensions 172 when the body 104 is in the use position. In one embodiment, as shown in FIGS. 16, 20 and 21, a spring 176 may be included on the pin 166 to force the pin out of the channel extensions when the body is pivoted in the direction of arrow A, causing the pins to move in the direction of arrow D.

In some embodiments, as shown in FIG. 16, the floor treatment appliance includes a switch 190 or other sensor component to power down at least a portion of the appliance when the body is brought to the storage position. As previously discussed, during use, the lower portion of the appliance may be brought fully forward, or nearly fully forward, while the upper portion of the body is swiveled relative to the lower portion. Bringing the lower portion forward may cause the appliance to shut off while the appliance is being used. To prevent powering off the appliance during use, embodiments disclosed herein include a switch or other sensor that is not activated when the body is swiveled.

In one embodiment, the switch may be located on the appliance head or it may be located in the body. In one embodiment, the switch 190 is a normally open, spring-biased switch located on an extension 167 of the lock-prevention member, as shown in FIG. 20. The extension 167 may be formed as part of the arch 169. When the switch is pushed into a closed state, a controller is signaled to turn off the appliance. The switch may travel on the lock-prevention member and when the body is pivoted fully forward, the switch may be pressed against a surface and become closed. To prevent activation of the switch when the body is swiveled, the lock prevention member may be arranged such that the switch cannot move all the way to the contact surface when the body is swiveled.

For example, FIGS. 16-21 illustrate the switch 190 on the pin assembly in the normally open position. When the body is in a non-home swiveled position, as in FIG. 16, the pins contact a surface of the swivel disk and prevent the switch from contacting a surface 192. When the body is the home swivel position, however, as shown in FIG. 7, the pins may extend through the channel extensions 172, allowing the switch to be pressed against the contact surface 192. The particular manner of mounting the switch is not intended to be limiting.

Instead of a normally open, spring-biased switch, any suitable type of sensor may be used to trigger shut down of the appliance or portion thereof. For example, an optical sensor may be used to sense when a portion of the appliance body is brought to a fully forward position with the body in a non-swiveled position.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. An appliance comprising:
an appliance head having a front edge and a rear edge;
a body which is pivotally movable relative to the appliance head, the body including a lower body portion and an upper body portion;
a handle grasping portion;
a swivel joint which permits the lower body portion to swivel relative to the upper body portion, the lower body portion being below the swivel joint, to and the upper body portion being above the swivel joint; and
a connection between the lower body portion and the appliance head, wherein
at least a portion of the connection between the lower body portion and the appliance head is located forward of the rear edge of the appliance head by at least one quarter of a distance between the rear edge and the front edge.

2. An appliance as in claim 1, wherein:
the body has a first slope at the swivel joint;
the swivel joint has a rotation axis;
an imaginary line extending from the handle grasping portion to the rotation axis at the swivel joint has a second slope; and
the first slope is less than the second slope.

3. An appliance as in claim 1, wherein:
the swivel joint has a rotation axis;
an imaginary line extending from the handle grasping portion to the rotation axis at the swivel joint has a second slope; and
the rotation axis has a slope which is less than the second slope.

4. An appliance as in claim 1, wherein the appliance head has a top, and the lower body portion is connected to top of the appliance head.

5. An appliance as in claim 4, wherein the lower body portion is connected to the appliance head approximately halfway between a front edge of the appliance head and the rear edge of the appliance head.

6. An appliance as in claim 1, wherein the lower body portion is connected to the appliance head approximately halfway between a front edge of the appliance head and the rear edge of the appliance head.

7. An appliance as in claim 1, wherein the appliance head includes a moveable to member that is moveable relative to the appliance head in a reciprocating motion.

8. An appliance as in claim 1, wherein the appliance head includes at least two moveable members that are moveable relative to the appliance head in a reciprocating motion.

9. An appliance as in claim 8, wherein the at least two moveable members comprise two moveable member that are moveable toward and away from each other in a reciprocating motion.

10. An appliance as in claim 1, wherein the lower body portion includes a pivot joint which pivotally connects the appliance body to the appliance head.

11. An appliance as in claim 10, wherein the lower body portion has extending ends forming a yoke-shaped portion, and the extending ends form at least part of the pivot joint between the appliance body and the appliance head.

12. An appliance comprising:
an appliance head;
a body which is pivotally movable relative to the appliance head, the body including a lower body portion and an upper body portion;
a handle grasping portion; and
a swivel joint which permits the lower body portion to swivel relative to the upper body portion, the lower body portion being below the swivel joint, and the upper body portion being above the swivel joint;
wherein:
the body has a first slope at the swivel joint;
the upper body has a second slope above the swivel joint;
the lower body has a third slope below the swivel joint; and
the first slope is less than the second slope and the third slope.

13. An appliance as in claim 12, wherein the third slope is greater than the second slope.

14. An appliance as in claim 12, wherein the appliance head has a top, and the lower body portion is connected to the top of the appliance head.

15. An appliance as in claim 12, further comprising a pivot joint having a pivot axis about which the lower body portion pivots relative to the appliance head, the pivot axis being located forward of the rear edge of the appliance head by at least one quarter of a distance between the appliance head rear edge and the appliance head front edge.

16. An appliance as in claim 15, wherein the pivot axis is located forward of the rear edge of the appliance head by at least one half of the distance between the appliance head rear edge and the appliance head front edge.

17. An appliance comprising:
an appliance head;
a body which is pivotally movable relative to the appliance head, the body including a lower body portion and an upper body portion;
a handle grasping portion; and
a swivel joint which permits the lower body portion to swivel relative to the upper body portion, the lower body portion being below the swivel joint, and the upper body portion being above the swivel joint;
wherein the lower body portion extends from the appliance head at a first angle relative to a horizontal reference plane, and the lower body portion has a curve such that an upper region of the lower body portion forms a second angle relative to the horizontal reference plane that is smaller than the first angle.

18. An appliance as in claim 17, wherein the upper body portion extends from the swivel joint at a third angle relative to the horizontal reference plane, and the upper body portion has a curve such that the upper body portion has a fourth angle relative to the horizontal reference plane that is greater than the third angle.

19. An appliance as in claim 17, wherein the appliance head has a top, and the lower body portion is connected to top of the appliance head.

20. An appliance comprising:
an appliance head;
a body including a lower body portion and an upper body portion, wherein the body is pivotally movable relative to the appliance head;
a handle grasping portion;
a swivel joint which permits the lower body portion to swivel relative to the upper body portion, the lower body portion being below the swivel joint, and the upper body portion being above the swivel joint;
wherein:
the swivel joint has a swivel axis which, when extended along an imaginary axis, passes above the pivot axis.

21. An appliance comprising:
an appliance head;
a body including a lower body portion and an upper body portion, wherein the body is pivotally movable relative to the appliance head;
a handle grasping portion;
a swivel joint which permits the lower body portion to swivel relative to the upper body portion about a swivel axis, the lower body portion being below the swivel joint, and the upper body portion being above the swivel joint;
wherein:
an imaginary line extending from the handle grasping portion to the swivel axis at the swivel joint forms an angle with the swivel axis of less than 130 degrees on the side of the swivel joint where the swivel axis points downwardly.

22. An appliance as in claim 21, wherein the imaginary line extending from the handle grasping portion to the swivel axis at the swivel joint forms an angle with the swivel axis of 125 degrees or less.

23. An appliance as in claim 21, wherein the imaginary line extending from the handle grasping portion to the swivel axis at the swivel joint forms an angle with the swivel axis of between 115 and 125 inclusive.

24. An appliance as in claim 23, wherein the appliance head rotates about an vertical axis by between sixty and seventy degrees when the upper body portion is rotated about an imaginary line between the handle grasping portion and the swivel axis at the swivel joint by ninety degrees.

25. An appliance as in claim 21, wherein the appliance head comprises two linearly moveable members that move toward and away from each other.
